(19) United States
(12) Patent Application Publication
(10) Pub. No.: US 2006/0178777 A1
(43) Pub. Date: Aug. 10, 2006

(54) Home network system and control method thereof

(75) Inventors: Jong-Ho Park, Yongin-si (KR); Jae-Seok Park, Seoul (KR); Jun-Ku Kim, Seoul (KR); Jong-Chang Lee, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/348,496

(22) Filed: Feb. 6, 2006

(30) Foreign Application Priority Data
Feb. 4, 2005 (KR) 2005-0010832

(51) Int. Cl. B29C 45/00; G06F 19/00

(52) U.S. Cl. 700/245; 704/275

(57) ABSTRACT

A home network system and a control method thereof. A user with a mobile station at a remote location can control a home robot and monitor security conditions and home appliance conditions at a house via a wireless network. In the home network system, the mobile station is adapted to transmit a control request message for the remote control of the home robot and monitoring-request messages for the monitoring at a house via a first network, and receive control result information related to the home robot control and monitoring information via the first network for display. A server is adapted to analyze the request messages received from the mobile station via the first network, transmit a corresponding request message to the home robot via a second network, and receive the control result information and the monitoring information from the home robot via the second network to transmit to the mobile station.

### PRIORITY

This application claims priority under 35 U.S.C. § 119 to an application entitled “HOME NETWORK SYSTEM AND CONTROL METHOD THEREOF” filed in the Korean Intellectual Property Office on Feb. 4, 2005 and assigned Serial No. 10-2005-0010832, the contents of which are incorporated herein by reference.

### BACKGROUND OF THE INVENTION

1. Field of the Invention

The present invention relates to a home network system, and more particularly, to a home network system and a control method thereof which are designed to remotely control and monitor a home robot by using a wireless station.

2. Description of the Related Art

Due to current development in Internet and information communication technologies, social value, culture and lifestyle are rapidly changing. New worlds, as previously seen only in movies or cartoons, can be experienced by a computer or a robot. Computers and communication devices can be used at any time and at any place. Ubiquitous networks, supporting human friendly services, are in the early stage of introduction. The so-called Information Technology (IT) Revolution, comparable to Industrial Revolution, is now spreading all over the globe.

In the robotics field, industrial robots have been installed in access-controlled areas of factories to carry out repeated operations or hard manual labor in place of humans. Lately, the industrial robot market has been saturated, slowing down its growth. Thus, attempts to develop robots as a home appliance or personal article are being pursued actively over the world, so that the robots can be easily used in the everyday lives of people.

Such change seems very positive considering that the intelligent robot market can be led by venture-type and small-sized companies in which products can be developed with various vivid ideas, showing massive development potential and a ripple effect on commerce. This is in contrast to the conventional industrial robot market, which has been established by large enterprises having their own market sectors such as automobiles or mass product home appliances, which has the potential for small coverage and limited growth.

Furthermore, by combining IT technologies of global competitive power to conventional robot technologies, it is possible to realize a “network-based robot” or “ubiquitous service robot” that can raise added value while limiting prices. Then, it is anticipated that a new age will come, in which robots can be used as a mobile station. That is, at present most robots are expensive and specialized to a specific purpose with a fixed function and content, and thus lose their attractiveness for users in a short period. However, by developing low cost intelligent robots, supplying the robots in the form of terminals like a mobile communication terminal (or mobile station), and providing various service content to the robots via network, it is possible to enhance the added value of the robots, as well as significantly expand market.

Among the various robot types is a home robot. The home robot, capable of providing various home services related to the invention, means a home service robot that can move on wheels while providing information service via wireless networks, security and monitoring service at home and data transmission and real-time monitoring service via mobile IT devices.

For the information service, the home robot may search various desired information such as weather, traffic, investments and general news reports via the Internet, and provide the searched information to a user with voice or image. Compared to the PC, the home robot has a competitive advantage because it can move by itself, provide the user with voice and image information friendly to him/her, and search information, by itself, to provide to the user.

Such a home robot and a home network system for controlling the same is disclosed in Korean Patent Application Publication No. 10-2002-0070444 entitled “Home Robot Using Home Server and Home Network Having the Same”, filed Nov. 13, 2002 and commonly assigned to the assignee of this application. In addition, a home network system is also disclosed in Korean Patent Application Publication No. 10-2002-0071671 titled “Home Robot Using Supercomputer, and Home Network System Having the Same”, filed Nov. 18, 2002 and commonly assigned to assignee of this application.

FIG. 1 is a diagram illustrating a home network system of the prior art (Korean Patent Application Publication No. 10-2002-0071671). As shown in FIG. 1, the home network system of the prior art includes supercomputers 10, a home gateway 30 and a home robot 40. The home gateway 30 is connected with the supercomputers 10 by a physical network, and the home network 40 is connected with the home gateway 30 by a wireless network comprising at least one of a Radio Frequency (RF) network, a Bluetooth network and a Wireless Local Area Network (WLAN) network.

Each of the supercomputers 10 receives a wireless signal transmitted from the home robot 40 via the home gateway 30. Upon receiving the wireless signal from the home robot 40 via the home gateway 30, the supercomputer 10 extracts a user command and status data on the robot from the wireless signal to analyze, and execute calculations related to the analyzed user command and for controlling the operation of the home robot 40. According to the calculation result, the supercomputer 10 generates a voice or image acknowledgment signal to be generated by the home robot 40 and an operation control signal for the control of the home robot 40, and then transmits the signals to the home robot 40 via the home gateway 30.

When the robot 40 is initially operated by the supercomputer 10, a process is performed to register the robot in a database (DB) of the supercomputer 10. Registration is required to be performed once. Registration is required for both the supercomputer 10 and the home robot 40. This is similar to a process of registering unique identifier (ID) of a mobile station with a mobile communication provider at the initial startup of the mobile station.

When a user gives a voice command to the home robot 40 after the registration, the home robot 40 performs Analog-to-Digital (A/D) conversion of the voice signal from the user, and transmits the converted voice signal to the supercomputer 10 via the home gateway 30. No more processing is carried out in the home robot 40. Methods for giving the command to the home robot 40 are not restricted to voice, but may also use a touch screen or a wireless keyboard. However, the home robot 40 is supposed to have a most simple structure, and thus explanations of the other known types are omitted.

When receiving the command from the home robot 40, the home gateway 30 converts the Wireless Local Area Network (WLAN) data into data suitable for an external network which the home gateway 30 accesses, adds an ID of the home robot 40 to the data and transmits it to the supercomputer 10. In this process, the home gateway 30 constantly accesses the home robot 40.

The supercomputer 10 confirms the home gateway 30 location fixed at home and the ID of the home robot 40 before performing a requested command. Therefore, a security problem does not take place, even if the robot is lost or stolen.

The supercomputer 10 analyzes the command using an internal voice-recognizing module, obtains a voice command result and operates a corresponding service module. A service request command may be for a common service or for an individual service.

The home robot 40 can be composed of basic modules such as a Central Processing Unit (CPU), a microphone, an Liquid Crystal Display (LCD), a speaker and a network module. That is, the home robot 40 does not have to include sub-processors by functions and modules like a general robot. It is thus possible to reduce unit cost and battery consumption by forming the robot 40 with a minimum number of basic modules.

However, in the conventional home network system as described above, the home robot is controlled only after the user inputs a control command into the home robot 40, and the home robot 40 communicates with the supercomputer 10 under the control command from the user. In this case, the user can control the robot or be provided with other additional services by inputting commands, for example, with buttons attached to the home robot 40 or the wireless keyboard, or a voice command.

Accordingly, there are drawbacks in that the user cannot control the home robot or operate home security monitoring or Internet service functions if he/she is located remotely from home. That is, in order to control the robot, the user has to stay in a restricted area where the robot is located.

### SUMMARY OF THE INVENTION

The present invention has been made to solve the foregoing problems of the prior art and it is therefore an object of the present invention to provide a home network system and a control method thereof, by which a user with a mobile station can control a home robot and monitor security conditions within a house via a wireless network from a remote location.

According to an aspect of the invention for realizing the above objects, there is a home network control system including a home robot; a mobile station adapted to transmit a control request message for the remote control of the home robot and monitoring-request messages for the monitoring a home via a first network, and receive control result information related with home robot control and monitoring information via the first network for display; and a server adapted to analyze the request messages received from the mobile station via the first network, transmit a corresponding request message to the home robot via a second network, and receive the control result information and the monitoring information from the home robot via the second network to transmit to the mobile station.

Preferably, each of the control request messages and the monitoring-request messages may contain at least one message information item of real-time dynamic image data at the house photographed by the home robot, map information at the house, key-map information on the mobile station for controlling the home robot, setting-change request information on the change of home robot setting, setting-confirmation request message on the change of home robot setting and home robot selection information if a number of home robots exist.

According to another aspect of the invention for realizing the above objects, there is a control method of a home network system using a mobile station, including transmitting a control request message for the remote control of a home robot and monitoring-request messages to a server via a first network; at the server, interfacing the received request messages to the home robot via a second network and receiving control result information and monitoring information from the home robot to transmit to the mobile station via the first network; and at the mobile station, displaying the control result information and the monitoring information received from the server via the first network.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a home network system of the prior art;

FIG. 2 is a diagram illustrating a home network system of the invention;

FIG. 3 illustrates an exemplary main menu window displayed on a mobile station for controlling the home network system of the invention;

FIG. 4 illustrates an exemplary dynamic image window displayed on the mobile station when “Real-Time Image” is selected from the main menu window as shown in FIG. 3;

FIGS. 5A and 5B illustrate an exemplary key-mapping structure displayed on the mobile station when “Key-Map Switching” is selected from the real-time image window as shown in FIG. 4 in order to control a home robot;

FIG. 6A illustrates an exemplary window displayed on the mobile station when “MAP Information” is selected from the main menu window as shown in FIG. 3;

FIG. 6B illustrates examples of keys displayed on the map window as shown in FIG. 6A;

FIG. 7A illustrates an exemplary window in use for setting environmental values of a home robot displayed on the mobile station when “Robot Setting” is selected from the main menu window as shown in FIG. 3;

FIG. 7B illustrates an exemplary window in use for setting the number of sampling frames of a dynamic image taken by a camera of a home robot displayed on the mobile station when “Robot Setting” is selected from the main menu window as shown in FIG. 3;

FIG. 8A illustrates an exemplary window for displaying robot position information displayed on the mobile station when “Robot Information” is selected from the main menu window as shown in FIG. 3;

FIG. 8B illustrates an exemplary window for displaying photographic information for a camera mounted on a home robot displayed on the mobile station when “Robot Information” is selected from the main menu window as shown in FIG. 3;

FIG. 8C illustrates an exemplary window for displaying other home robot information displayed on the mobile station when “Robot Information” is selected from the main menu window as shown in FIG. 3; and

FIG. 9 illustrates an exemplary robot selection window displayed on the mobile station allowing a user to select a robot when “Robot Replacement” is selected from the main menu window as shown in FIG. 3.

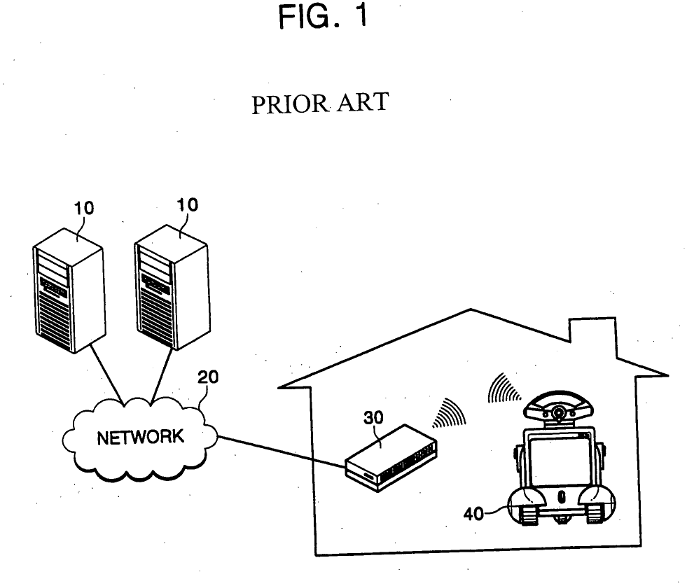

### DETAILED DESCRIPTION OF THE PREFERRED EMBODIMENTS

The following detailed description will present preferred embodiments of a home network system and a control method thereof according to the present invention with reference to the accompanying drawings.

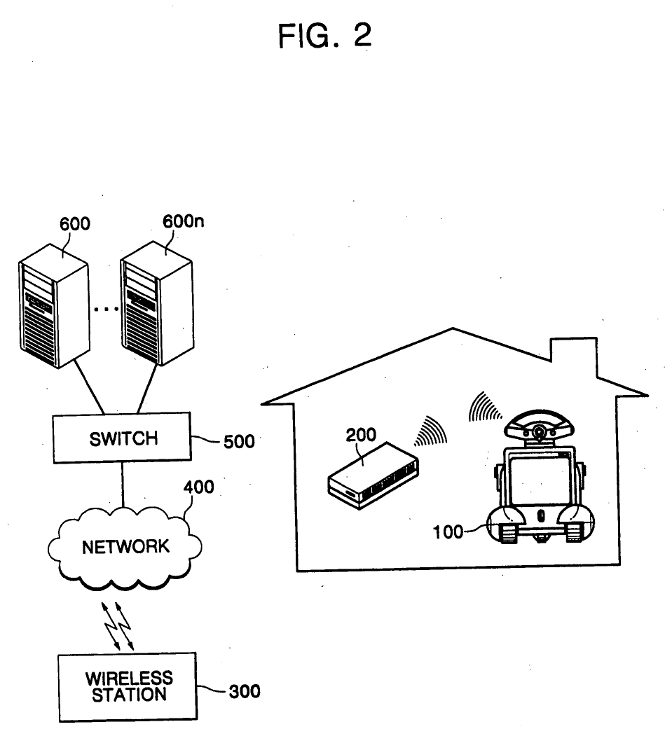

As shown in FIG. 2, the home network system of the invention includes a home robot 100, a home gateway 200, a mobile station 300, a switch 500 and servers 600-600n. The mobile station 300 can be connected to the switch 500 via a wireless network 400, which may comprise for example a Code Division Multiple Access (CDMA) network. The home robot 100 communicates with the home gateway 200 via wireless communication, which may employ for example RF communication, WLAN communication and Bluetooth communication.

The mobile station 300 accesses the servers 600-600n connected with the switch 500 via the network 400, transmits a control request message for controlling the home robot 100 in a house, and receives an acknowledgment message in response to the control request message from a corresponding one of the servers 600-600n through the switch 500 and the network. Those functions of controlling the home robot 100 through the server 600-600n by using the mobile station 300 may include functions for monitoring a dynamic image in the house taken in real-time by the home robot 100 and for monitoring a map plotting the position of the home robot 100 in the house. In order to control the home robot 100, the mobile station 300 can set for example moving speed information, camera angle adjustment information and camera rotation information of the home robot 100.

The mobile station 300 can also monitor the current status of the home robot 100, and has an authority of robot replacement in order to control a plurality of robots 100. The home robot 100 is located in a house. When the mobile station 300 makes a control instruction, the home robot 100 performs a corresponding function in response to a control request message from the server 600 (server 600 will be denoted as the accessed server for the remaining discussion). The home robot 100 can perform a plurality of functions in response to a request from the mobile station 300. The home robot 100 may provide dynamic images at the house via the server 600 to the mobile station 300. The home robot 100 also may move or roam about the house inspecting guard and security status of the house to report an inspection status to the mobile station 300 via the server 600 in a preset time period or at every request from the user.

The servers 600-600n are connected mutually via the switch 500, and provide different content information to the mobile station 300.

The server 600, upon receiving messages such as a request message for the control of the home robot 100 from the mobile station 300 and a message requesting the home robot 100 to monitor situations in the house, provides the messages to the home gateway 200 via the switch 500. The home gateway 200 transmits the request messages received from the server 600 to the home robot 100 via wireless communication. The wireless communication performed between the home gateway 200 and the home robot 100 may employ a wireless network such as WLAN, Bluetooth and RF network.

The operation of the home network system of the invention having the afore-described construction and a control method thereof will now be described in detail with reference to the accompanying drawings.

First, by using the mobile station 300, it is possible to control the home robot 100 for various functions such as watching real-time images in a house; setting the home robot; changing home robot information; and changing the home robot.

First, when the mobile station 300 accesses the server 600 to control the afore-mentioned functions, the server 600 requests authentication from the mobile station 300. That is, the server 600 requests the mobile station 300 to input authentication information (e.g., password information and ID information) required for authentication.

In response to the request from the server 600, the mobile station 300 inputs allocated password information and ID information to transmit to the server 600 via the network 400. The server 600 compares authentication information received from the mobile station 300 with preset authentication information of the mobile station 300 to authenticate the mobile station 300.

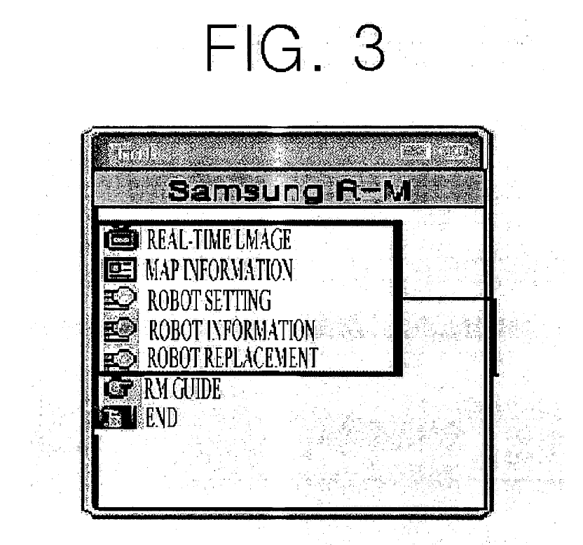

After the authentication is completed, the mobile station 300 is logged in to the server 600. When the user selects a main menu key of the mobile station 300 to control the home robot 100, a main menu window for controlling the home robot 100 is displayed on a display unit (e.g., an LCD window) of the mobile station 300 as shown in FIG. 3.

When the main menu window for controlling the home robot 100 is displayed, the user selects a control menu from the displayed main window. The control menu displayed on the displayed main window may include “Real-time Dynamic Image”, “MAP Information”, “Robot Setting”, “Robot Information” and “Robot Replacement.” It is to be understood that the menu can be composed with various other selections than the above-mentioned.

The operation by each menu will be described beginning with “Real-time Dynamic Image.”

When the user selects the real-time dynamic image from the main menu as shown in FIG. 3 with the mobile station 300 logged in the server 600, a corresponding dynamic image request message is sent to the switch 500 via the network, and the network 500 switches the request message to the server 600 that provides dynamic images. The dynamic image request message transmitted from the mobile station 300 to the server 600 may contain mobile station information and destination information, i.e., address information of the destination server 600. Accordingly, the switch 500 allocates an Internet Protocol (IP) address to the mobile station 300, and switches allocated IP address information on the dynamic image request message to the server 600.

In response to the dynamic image request message from the mobile station 300, the server 600 provides the request message via the switch 500 to the home gateway 100, which wirelessly transmits the request message to the home robot 100. In response to the request from the server 600, the home robot 100 operates a camera mounted thereon to photograph images in the house and wirelessly transmits photographed real-time dynamic image data to the home gateway 200.

The home gateway 200 transmits the real-time dynamic image data from the home robot 100 to the server 600, which has requested the dynamic image data via the switch 500.

The server 600 compresses the real-time dynamic image data in the house received via the switch 500 into a preset frame to wirelessly transmit to the mobile station 300 via the switch 500 and the network 400. In this case, the server 600 compresses the real-time dynamic image data based upon mobile station information stored therein. For example, the user registers his/her own information together with mobile station 300 information in the server 600, in which the registration information may include mobile station product number, specification information (e.g., LCD window size) and so on. The specification information may also include key-map information of the mobile station 300.

As a result, the server 600 compresses the image data according to the LCD size and the communication frequency bandwidth of the mobile station, when transmitting the dynamic image. The compressed frame may be of about 1 to 5 frames.

When the real-time image data in the house is transmitted from the server 600 or 600n, the mobile station 300 receives the image data to display on the LCD window according to the LCD size.

Where the real-time dynamic image data in the house is displayed, if the user wants to monitor each location in the house, he/she has to control the position of the home robot 100. That is, the user can control the position of the home robot 100 in order to ensure a whole dynamic image data of the whole house.

While the real-time image data in the house is being displayed on the mobile station 300, the user can control the home robot 100 to move or change camera angle by using keys mapped on the mobile station 300. For example, when the user wants to move the home robot 100 forward or backward, the user can operate “Up” and “Down” keys to control the forward and backward movement of the home robot 100. Moving the home robot 100 to the right and left can be controlled with “Right” and “Left” keys on the mobile station 300. While the key-mapping will be described hereinafter, this can be set by the user arbitrarily. The set key-mapping data is provided to the server 600, which controls the position movement of the home robot 100 by using this data. Also, the angle of the camera mounted on the home robot 100 can be also adjusted by using a preset key.

When the user inputs a preset key signal for the position movement of the home robot 100 or the angle adjustment of the camera by using the mobile station 300, the key signal is provided to the server 600 via the network 400. The server 600 judges which function is to be controlled by analyzing the key signal, and transmits a control request signal to the home gateway 200 via the switch 500.

Upon receiving the control request signal from the server 600 via the switch 500, the home gateway 200 wirelessly transmits the control request signal to the home robot 100 so that the home robot 100 can perform a corresponding function.

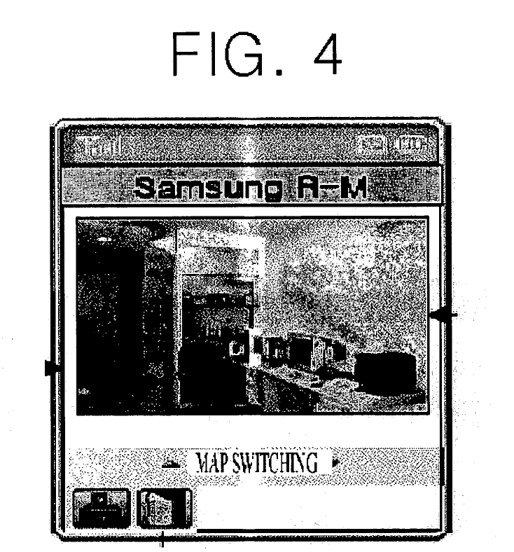

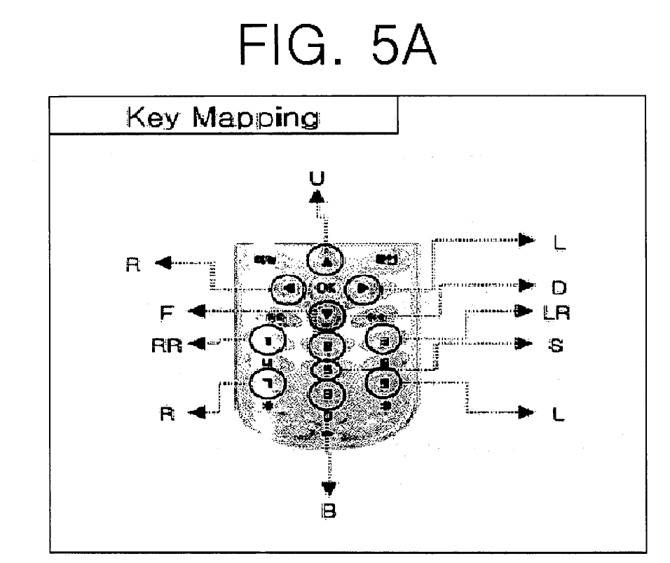

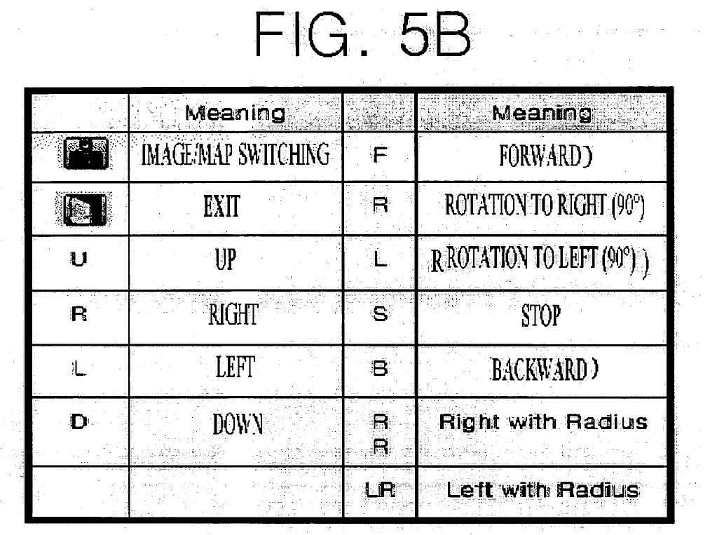

While the real-time dynamic image data is being displayed, an additional menu of “Key-MAP Switching” may be displayed so that the user can easily identify the function of individual keys for the position control of the home robot 100 as shown in FIG. 4. While watching the real-time dynamic image data, if the user selects afore-mentioned “Key-MAP Switching” for the purpose of the position control or the angle adjustment of the home robot 100, the mobile station 300 transmits a request message, which requests key-map information selected by the user, to the server 600 via the network 400. In response to the key-map information request message from the mobile station 300, the server 600 searches for the key-map information on the mobile station 300 to transmit to the mobile station 300 via the network 400. As a result, the mobile station 600 displays the key-map information received from the server 600 as shown in FIG. 5A. The key-map information displayed in FIG. 5A is an example, but it is to be understood that various key-map information representation can be formed according to the type of mobile station (e.g., a key configuration). That is, the server can realize various key-map configurations for a mobile station by using product number information and specification information of the mobile station achieved at the initial registration thereof. While the key-map can be configured according to the mobile station type, it is also to be understood that the key-map can be table-shaped as shown in FIG. 5B. Accordingly, the user can control desired functions by using displayed key-map information. In order to switch again to the real-time dynamic image window from the key-map information display, a preset key or an icon shaped as a camera as shown in FIGS. 4 and 5B can be selected, so that real-time dynamic image data photographed by the home robot 100 is received via the server 600 and displayed. As a result, it is possible to easily switch the real-time dynamic image data with the key-map information by selecting the preset key or icon. Now a discussion will be made of map information of the home and the operation of monitoring the present position of the home robot 100 on a map by using the mobile station 300. Herein, the map designates a structure at the house such as rooms, home appliance arrangements and door positions. When the user selects “MAP Information” from the main menu displayed on the mobile station 300 as shown in FIG. 3, the mobile station 300 transmits a MAP information request message to the server 600 via the network 400 and the switch 500. In response to the MAP information request message received from the mobile station 300 via the network 500, the server 600 reads map information that it possesses for the home associated with the mobile station 300. The server 600 transmits the map information to the mobile station 300 via the network 400. Map data transmitted from the server 600 to the mobile station 300 are text data, according to X-Y coordinates for each structure.

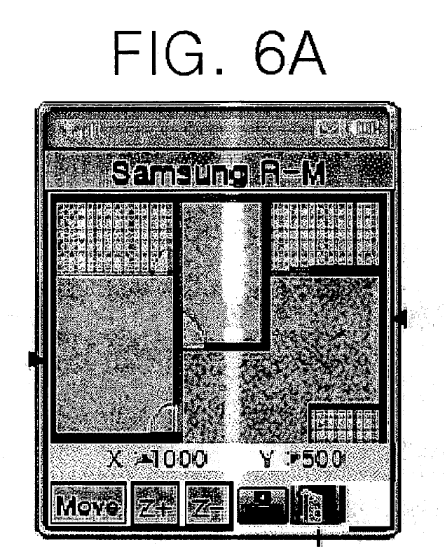

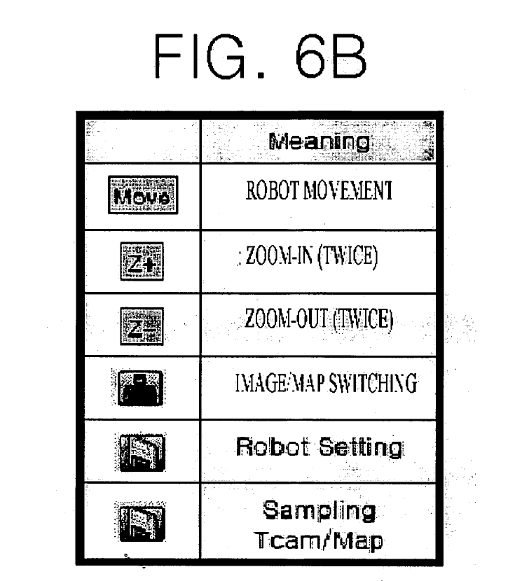

The mobile station 300 performs image-processing on the map data received from the server 600 into the form of a block as shown in FIG. 6A to display on the LCD window of the mobile station 300. In this case, the mobile station 300 may store the MAP data, which was received at an early stage, and with the passage of a certain time, request new MAP data so as to use the new map data received from the server 600 as comparison data for version updating.

The following describes performing version updating of map data. The user may change structures in the house by accessing the server 600. If the home robot 100 is an intelligent one having a map-building function, the home robot 100 may scan structures at the house periodically or at the request of the user and provide X-Y coordinates of the scanned structures to the server 600, thereby enabling map data to be updated. With the map-building function, the home robot 100 collects image data from surroundings in an unfamiliar environment to produce its map. Since the map-building by the intelligent home robot 100 is known to the art, detailed description thereof will be omitted.

The server 600, after transmitting the map data to the mobile station, requests the home robot 100 to provide its position information via the gateway 200. Then, the home robot 100 calculates its position into X-Y coordinates to provide to the server 600 via the home gateway 200. Upon receiving the position information of the home robot 100 from the home robot 100, the server 600 converts the position information into text data to transmit to the mobile station 300 via the network 400.

As a result, the mobile station 300 can locate the home robot on the map window currently displayed, based upon the position information that the home robot 100 received from the server 600.

In this case, when the user controls the position of the home robot 100 by using the mobile station 300, the home robot 100 continually transmits its position information to the server 600 as it changes position and the server 600 transmits the position information received from the home robot 100 to the mobile station 300 so that the home robot 100 can be located on the map window continuously. Where real-time images are displayed as described above, when the user selects “Zoom-in” or “Zoom-out”, the mobile station 300 transmits a corresponding signal to the server 600. The server 600 transmits the zoom-in or zoom-out signal from the mobile station 300 to the home robot 100 via the home gateway 200, and the home robot 100 zooms the camera, in or out, in response to the zoom-in or zoom-out signal received from the server 600. As the camera takes dynamic images through zooming in or out, the home robot 100 transmits dynamic image data to the mobile station 300 via the server 600, so that the mobile station 300 displays the zoomed-in or zoomed-out real-time dynamic images on the window.

Where map information is displayed as shown in FIG. 6A, by selecting a preset key or a “Z+1” or “Z−” icon as shown in FIG. 6A or 6B, it is possible to zoom in or out the map window directly. By selecting a preset key for tilting and swiveling the window (i.e., moving the window vertically and laterally) or a “Move” icon as shown in FIG. 6A or 6B, it is possible to move the window vertically or laterally to watch in more detail.

By selecting “Robot Setting” from the home robot control main window of the mobile station 300 as shown in FIG. 3, it is possible to set the environment of the home robot 100. The home robot 100 can be set by user selection according to rotation angle information of the camera mounted on the home robot 100, step information in the movement of the camera, image sampling number information and so on.

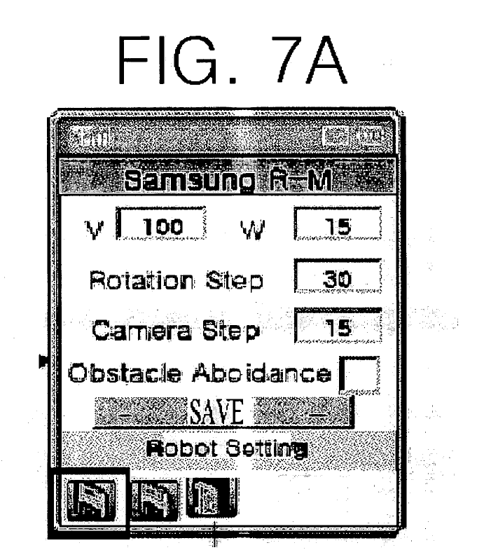

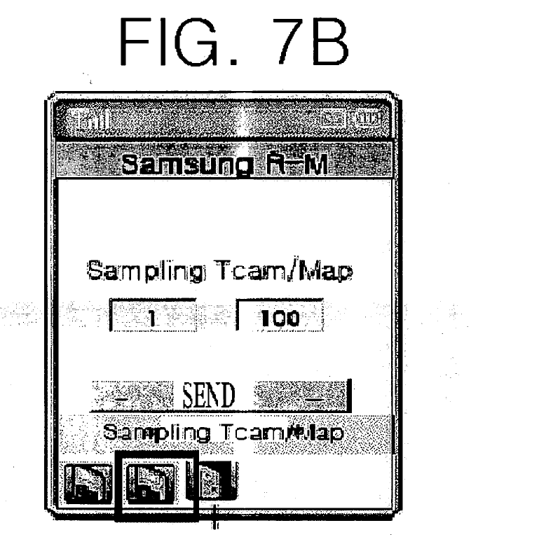

First, when the user selects “Robot Setting” from the main control window of the home robot on the mobile station 300, a robot setting window as shown in FIG. 7A or 7B is displayed. The robot setting window can be displayed by a program preset in the mobile station 300. Alternatively, the mobile station 300 may display the robot setting window by requesting and receiving window image data from the server 600. Where the robot setting window is displayed as shown in FIG. 7A or 7B, the user sets a desired environment by inputting a preset value. As setting is completed, set data is transmitted to the server 600 via the network. The server 600 stores and registers the environment setting data of the home robot 100 received from the mobile station 300 via the network 400 in a database managed by the server 600, and then transmits corresponding data to the home robot 100 via the home gateway 200.

Then, the home robot 100 updates corresponding data by using the environment setting data received from the server 600. As a result, under the home robot control request from the mobile station 300, the home robot 100 performs the corresponding function based upon updated value.

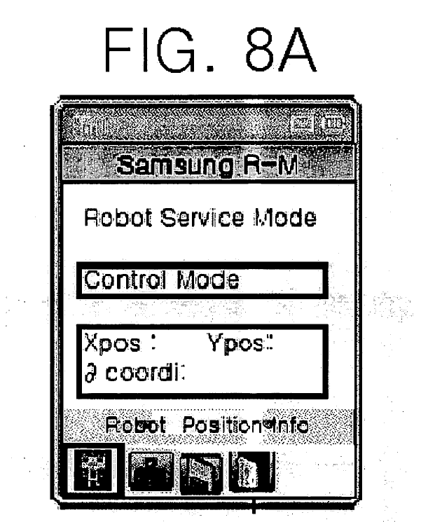

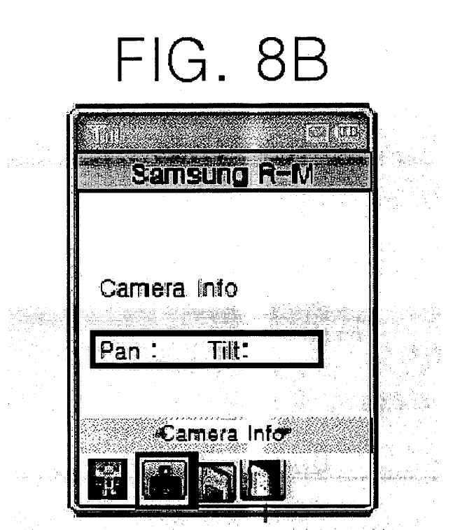

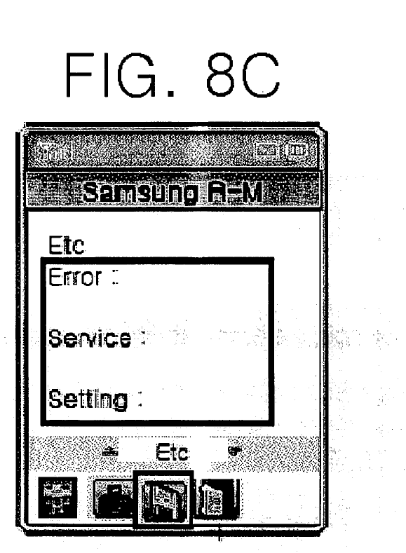

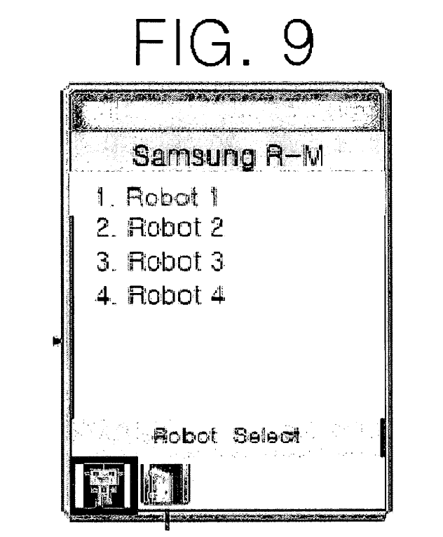

If “Robot Information” is selected from the main window as shown in FIG. 3, the mobile station 300 transmits a robot information request message to the server 600 via the network 400, and in response to the request from the mobile station 300, the server 600 transmits present position information of the home robot 100 and detailed camera information to the mobile station 300 to display windows, as shown in FIG. 8A to 8C. That is, the mobile station displays the present position information (X-Y coordinates) of the home robot 100 and detailed camera information (e.g., panning or tilting angle) in different windows according to user selection. If a plurality of home robots 100 exist in the house, the user can select a specific home robot 100 to control by using the mobile station 300. That is, when the user selects “Robot Replacement” from the main menu window as shown in FIG. 3, a robot selection window is displayed as shown in FIG. 9. If the user selects one of the displayed robots, the mobile station 300 transmits selection information to the server 600 via the network 400. Then, the server 600 stops a currently operating home robot 100 via the home gateway 200, and activates another home robot 100 selected by the user.

When carrying out the replacement of the home robot 100, the server 600 provides stored information on the replaced home robot 100 to the mobile station 300 via the network 400, so that the user can control various functions as described above based upon the provided information. While the foregoing embodiment has been described as a method of controlling a number of home robots with one mobile station, a single home robot may also be controlled from a number of mobile stations. When one of a plurality of mobile stations makes a first access for control of a robot, this mobile station acts as a master. Then, other mobile stations act as slaves (or sub-stations), which are authorized to monitor real-time dynamic images or home map information without controlling the home robot or changing information. The server 600 is required to store and manage information of the mobile stations, and can grant afore-mentioned authority based upon the information of an accessing mobile station. Alternatively, the server 600 can designate one of the mobile stations as a master and other ones as slaves (or sub-stations) so that the master is authorized to control all functions of the home robot while executing information change while the slaves are granted with a monitoring function only.

Additionally, authority may be granted to the first accessing mobile station, without granting even a monitoring function to other stations.

With these alternative methods, it is possible to carry out control functions such as home robot control, monitoring at a house, home robot information change and home robot setting in substantially the same fashion as in the foregoing embodiments. Thus, detailed description of the control methods will be omitted.

While the foregoing embodiments of the home network system and the control method thereof of the invention have been described for those functions such as real-time dynamic image, map information, robot setting, robot information and robot replacement, it is to be apparent to those skilled in the art that various other control functions as disclosed in Korean Patent Application Publication No. 10-2002-0070444 titled “Home Robot Using Home Server and Home Network System Having the Same” and No. 10-2002-0071671 titled “Home Robot Using Supercomputer, and Home Network System Having the Same”, both of which are commonly assigned to the assignee of the present application, and can be controlled with a mobile station and other control function can be modified as described hereinbefore. As described above, the home network system and the control method thereof allows the user to have remote control over the home robot at any time and at any place with the mobile station via the cooperating server, thereby affording convenience to the user as well as creating added value. In addition, situations at the house can be easily monitored with the mobile station, so that security conditions and home appliance conditions can be monitored at any time and at any place. This provides convenience for the user.

While the present invention has been shown and described in connection with the preferred embodiments, it will be apparent to those skilled in the art that modifications and variations can be made without departing from the spirit and scope of the invention as defined by the appended claims.

What is claimed is:

1. A home network control system comprising:
a home robot;
a mobile station adapted to transmit a control request message for remote control of the home robot and monitoring-request messages for monitoring a house via a first network, and to receive control result information related to home robot control and monitoring information via the first network for display; and
a server adapted to analyze the request messages received from the mobile station via the first network, transmit the corresponding request messages to the home robot via a second network, and receive the control result information and the monitoring information from the home robot via the second network to transmit to the mobile station.

2. The home network control system according to claim 1, wherein each of the control request messages and the monitoring-request messages includes at least one of real-time dynamic image data of the house photographed by the home robot, map information of the house, key-map information on the mobile station for controlling the home robot, setting-change request information on a change of the home robot setting, setting-confirmation request messages on the change of the home robot setting and home robot selection information if there exists a plurality of home robots.

3. The home network control system according to claim 2, wherein the setting-confirmation request messages include at least one of a plurality of sampling frames of dynamic image data photographed by the home robot to transmit to the server, a rotation angle of a camera mounted on the home robot and a movement step of the camera.

4. The home network control system according to claim 2, wherein real-time dynamic image data of the monitoring information transmitted from the server to the mobile station is compressed into a predetermined frame according to bandwidth of the mobile station and display size of the mobile station.

5. The home network control system according to claim 2, wherein map information transmitted from the server to the mobile station comprises text data of X-Y coordinates for structures of the house, and includes present position information of the home robot.

6. The home network control system according to claim 1, wherein the mobile station comprises a plurality of mobile stations registered for the control of the home robot, and the server is adapted to authorize a first accessing mobile station as a master, and other accessing mobile stations as sub-stations, the sub-stations being authorized to monitor real-time dynamic images and home map information.

7. The home network control system according to claim 1, wherein the mobile station comprises a plurality of mobile stations, and the server is adapted to allow home robot control and monitoring authority to a first accessing mobile station.

8. The home network control system according to claim 1, wherein the first network comprises a mobile communication network, and the second network comprises a local area wireless network, the local area wireless network comprising at least one of a Bluetooth network, a Radio Frequency (RF) communication network and a Wireless Local Area Network (WLAN).

9. The home network control system according to claim 1, wherein the mobile station is adapted to initially register product information including key-map information and Liquid Crystal Display (LCD) size information and authentication information in the server in order to control the home robot.

10. A control method of a home network system using a mobile station, comprising:
transmitting a control request message for remote control of a home robot and monitoring-request messages to a server via a first network;
at the server, interfacing the received request messages to the home robot via a second network and receiving control result information and monitoring information from the home robot to transmit to the mobile station via the first network; and
at the mobile station, displaying the control result information and the monitoring information received from the server via the first network.

11. The control method of a home network system according to claim 10, wherein each of the control request messages and the monitoring-request messages contains at least one of real-time dynamic image data of the house photographed by the home robot, map information of the house, key-map information on the mobile station for controlling the home robot, setting-change request information on a change of home robot setting, setting-confirmation request messages on a change of home robot setting and home robot selection information if there exists a plurality of home robots.

12. The control method of a home network system according to claim 11, wherein the setting-confirmation request messages includes at least one of a number of sampling frames of dynamic image data photographed by the home robot to transmit to the server, a rotation angle of a camera mounted on the home robot and a movement step of the camera.

13. The control method of a home network system according to claim 11, wherein real-time dynamic image data of the monitoring information transmitted from the server to the mobile station is compressed into a predetermined frame according to bandwidth of the mobile station and display size of the mobile station.

14. The control method of a home network system according to claim 11, wherein map information transmitted from the server to the mobile station comprises text data of X-Y coordinates for structures of the house, and includes present position information of the home robot.

15. The control method of a home network system according to claim 10, wherein the mobile station comprises a plurality of mobile stations registered for the control of the home robot, and the server is adapted to authorize a first accessing mobile station as a master, and other accessing mobile stations as sub-stations, the sub-stations being authorized to monitor real-time dynamic images and home map information.

16. The control method of a home network system according to claim 10, wherein the mobile station comprises a plurality of mobile stations, the server being adapted to allow home robot control and monitoring authority to a first accessing mobile station.

17. The control method of a home network system according to claim 10, wherein the first network comprises a mobile communication network, and the second network comprises a local area wireless network, the local area wireless network comprising at least one of a Bluetooth network, a Radio Frequency (RF) communication network and Wireless Local Area Network (WLAN).

18. The control method of a home network system according to claim 10, further comprising:
at the mobile station, initially registering authentication information, product information including key-map information, and Liquid Crystal Display (LCD) size information in order to control the home robot; and
at the server, if the mobile station accesses the server to control the home robot or request the monitoring information, executing authentication to the mobile station.
